(19) United States
(12) Patent Application Publication
(10) Pub. No.: US 2006/0249089 A1
(43) Pub. Date: Nov. 9, 2006

(54) Spill-proof pet bowl

(76) Inventor: Monty Behunin, Elko, NV (US)

Correspondence Address: Donald W. Meeker;Patent Agent, 924 East Ocean Front #E, Newport Beach, CA, 92661, US

(21) Appl. No.: 11/123,289

(22) Filed: May 6, 2005

(51) Int. Cl. A01K 5/01

(52) U.S. Cl. 119/61.57

(57) ABSTRACT

A spill-proof pet dish has a rigid mounting shaft with one of several height adjustable attaching means. A threaded lag bolt end of the shaft attaches to a flat support surface, such as a floor, deck, or patio. A corkscrew device at the end of the shaft for outdoor use screws into the ground. An L-shaped shaft with a clamp on the horizontal leg mounts to vertical elements, such as fence posts. A square Y-shaped shaft with two ramped locking mechanisms supports two pet bowls. A ramped locking mechanism at the top of the shaft removably locks in place a T-shaped locking post attached to the recessed bottom of the pet bowl for removable cleaning or remote refilling of the bowl.

### BACKGROUND OF THE INVENTION

1. Field of the Invention

The present invention relates to spill-proof pet dishes and in particular to one that is removably attachable to a ramped locking mechanism mounted by a screw to a wood surface or by a corkscrew device into the ground, both of which are adjustable in height by the length of insertion of the screw or corkscrew.

2. Description of the Prior Art

Bowls for holding food or water for pets such as dogs are well known, and typically the bowls are formed of a side wall with an interior dished portion for holding food or water. Pets often spill the contents of their dishes. This is especially true for some animals, such as large dog breeds, which may accidentally step on the perimeter of the bowl or kick the bowl, thereby causing it to flip over and spill the contents on the ground.

Prior attempts to solve this problem often involve extra structure beyond the simple food or water bowl to hold the bowl in some way with a secured container structure or stakes or prongs requiring means of attachment or extra indentations in the bowl.

Prior art U.S. Pat. No. D429,388, issued Aug. 8, 2000 to Irving, describes the ornamental design for a pet dish, which has a corkscrew for engaging the ground to prevent spills.

Prior art U.S. Pat. No. 5,526,773, issued Jun. 18, 1996 to Richardson, claims an anchored three-piece pet food water dish assembly, which is capable of withstanding spillage and inhibits the ability of crawling insects to access the food and water containers. The invention incorporates a feeder component with one or more container sections that are insertable into a holder component that itself is anchored to the ground. The holder component structure further incorporates an internal annular trench that, when filled with water, prevents access to the surrounded feeder component by crawling insects. The assembly allows for easy insertion and removal of the feeder component from the holder component in a manner that facilitates the addition or removal of food and water for the pet. The holder component structure allows for the ease of insertion and removal of the feeder component while still maintaining its isolation from the ground and crawling insects through means of the annular trench and still maintaining its stability through its nearly complete enclosure by the holder component.

Prior art U.S. Pat. No. 1,037,093, issued Aug. 27, 1912 to Wendorf, puts forth a feed box, which is provided with screws that protrude from the bottom for securing purposes.

Prior art U.S. Pat. No. 2,772,660, issued Dec. 4, 1956 to Saul, illustrates a ground secured animal drinking receptacle that comprises a bowl with a raised central portion, which has an orifice to accept a stake that can be driven into the ground.

Prior art U.S. Pat. No. 2,484,263, issued Oct. 11, 1949 to Atkinson, concerns a combination receptacle mounting and tie post for dogs, which has a stake for anchoring the device to the ground.

Prior art U.S. Pat. No. 4,546,730, issued Oct. 15, 1985 to Holland, provides a circular dog-run and feeding station that has a shade so that the animal is free to exercise within a complete circle. There is a feeding bowl provided with a vertical bearing receiving area for an elongated stake that is driven into the ground, whereby the bowl stabilizes the stake. An elongated pole is pivotally mounted to the stake above the bowl and a free end of the pole engages the ground. This free end of the pole is fitted with a flexible leash that is no longer in length than the pivoted pole. The free end of the leash is attached to the collar of the dog. An umbrella is mounted at the lower end of its vertical shaft to the upper end of the stake.

Prior art U.S. Pat. No. 5,628,276, issued May 13, 1997 to Raposa, provides a tip-resistant outdoor pet feeding or watering dish for that is secured upright, thereby preventing loss of food or water due to the pet tipping over the dish. The device has a post with a central aperture with a radially extending recess. The tip-resistant outdoor pet feeding or watering dish comprises an open bowl that has a closed planar bottom. The planar bottom has a hollow post projecting upwardly therefrom to slightly above the edge of the top of the bowl whereby liquid placed inside the bowl can not flow into the hollow post. The tip-resistant outdoor pet dish also includes a spike having a pointed lower end. The spike extends downwardly through the hollow post and is inserted into the ground under the dish whereby the dish may not be tipped by a pet animal. The spike has a radially extending projection adjacent to the upper end adapted to be received in the complimentary axial recess in the post of the dish.

Prior art U.S. Pat. No. D446,361, issued Aug. 7, 2001 to Elliott, shows the ornamental design for a pet food dish, which has prongs for securing the bowl to the ground.

Prior art U.S. Pat. No. 3,202,131, issued Aug. 24, 1965 to Jones, is for an anchored animal feeding bowl, which has a pair of pivotally mounted prongs located on the bottom. The prongs may be extended downwardly and uses as stakes for anchoring the bowl to the ground. For indoor use the prongs would be moved to a retracted position in recesses in the bottom of the bowl.

Prior art U.S. Pat. No. 5,000,123, issued Mar. 19, 1991 to Morse, discloses an anti-tipping feed dish that includes a series of suction cups to enhance securement of the bowl to a support surface. A further embodiment of the invention utilizes selectively reversible suction cups to permit selective removal thereof relative to the bowl and further providing usage of a support bowl frictionally engaging slidably receiving a feed bowl therewithin. In situations where the food dish is not placed on a support surface, a metal chain link has been firmly placed in the exterior wall so as the food dish may be staked if added securement is needed. This feature would be an additional feature on a dirt surface whereas the suction cups add additional securement on a support surface.

Prior art U.S. Patent Application #20020162511, published Nov. 7, 2002 by Hollinger, puts forth a pet bowl that has an interior dished portion for receiving pet food, water or the like that has a rather large suction cup held centrally to the underside of the pet bowl for securing the bowl to a surface such as a floor. The suction cup underlies at least a major portion of the lateral extent of the dished portion of the bowl, and may be held removably to the pet bowl by a bracket. The surface of the suction cup preferably has upstanding portions to engage the under surface of the bracket to depress the suction cup assuredly upon downward movement of the bowl. The bracket may have a keyed opening, and a knob with an enlarged end extends upwardly from the suction cup and may be fitted within the keyed opening to hold the suction cup removably to the bracket. Further, a tab may extend from the rim portion of the suction cup to be accessed through an opening in the sidewall of the pet bowl for enabling the rim of the suction cup to be lifted and release the suction cup from the floor.

What is needed is a pet bowl securing means, which can be used with standard pet bowls used for water and food and with a provision to enable the regular cleaning of the bowls and which are adjustable in height.

### SUMMARY OF THE INVENTION

An object of the present invention is to provide a pet bowl removably attachable to a ramped locking mechanism on a threaded shaft, such as a lag bolt, for securing to wooden structures, such as floors, decks or patios, and on a corkscrew means for securing in the ground, and which pet bowl can receive regular cleaning and filling by simply turning the bowl to unlock it from the ramped locking mechanism on the shaft left in place in the wood or the ground, and after cleaning or filling the bowl locking the bowl back in place.

A related object of the present invention is to provide a long preferably unthreaded shaft on the bolt or corkscrew to enable the screw or corkscrew to be inserted to any desired length leaving at least a portion of the shaft exposed above the surface of the wood or ground to elevate the bowl to a desired height above the wood or ground.

Another related object of the present invention is to utilize the normal recessed bottom of a stainless steel pet bowl or some plastic and ceramic pet bowls to receive a welded T-locking post welded to the bowl and a post receiving ramped locking mechanism from the screw or corkscrew shaft both fitting within the recess so that the pet bowl may rest evenly on the flat support surface with the bottom rim of the bowl contacting the flat surface if desired rather than elevating the bowl.

An alternate further object of the present invention is to provide both the lag screw with an attached ramped locking mechanism and the corkscrew with an attached ramped locking mechanism and the bowl with an attached T-post to allow use on both a floor and in the ground alternately or with two bowls and T-posts for simultaneous floor and ground use.

One more objective of the present invention is to provide a square Y-shaped mounting shaft with a ramped locking mechanism at the top of each of the arms of the Y and two bowls each with attached T-posts to provide both a water bowl and food bowl together.

Yet another object of the present invention is to provide an L-shaped shaft with a ramped locking mechanism at the top of the vertical leg and a clamp at the end of the horizontal leg for mounting on a fence or vertical element, such as a fence post, to mount the bowl at any desired height on a fence or railing having a post.

In brief, a pet bowl securing means, which can be used pre-attached to a preferably stainless steel bowl or attachable to standard pet bowls that hold water and food, which pet bowl securing means has a provision to enable the regular cleaning of the bowls and height adjustment. The device provides a threaded shaft, such as a lag bolt, for securing a pet dish to structures, such as floors, decks or patios or alternately such as a corkscrew means for securing a bowl to the ground for outdoor use. The pet bowl is removably attachable to the shafts by a T-post welded or screwed to the bottom of the bowl which is twisted to turn the T-post into and out of a ramped locking mechanism welded or screwed onto the top of the shaft. The bolt or corkscrew both have long shafts preferably unthreaded along most of the length so that the bolt or corkscrew may be screwed into a wooden floor or the ground leaving a portion of the shaft exposed to a desired height to elevate the bowl. This creates a spill-proof pet water and food bowl, which is adjustable in height and can receive regular cleaning or remote refilling by simply unscrewing the bowl from the bolt or corkscrew.

The device utilizes the normal recessed bottom of a stainless steel pet bowl or some plastic and ceramic pet bowls, which receives the T-post welded or adhered or screwed to the center of the recessed bottom. A ramped locking mechanism on the top of the bolt or corkscrew receives the T-post from the bottom of the bowl removably turned and ramped to a locking position onto the top of the bolt or corkscrew shaft with the bolt screwed into a wooden floor or the corkscrew screwed into the ground. This allows the pet bowl to be secured in an elevated position on the bolt or corkscrew with the shaft protruding, or with the shaft fully screwed onto the floor or ground allows the pet bowl to rest evenly on the floor or ground with the bottom rim of the bowl contacting the floor or ground with the ramped locking mechanism fitting within the recess in the bottom of the bowl.

The lag bolt with a ramped locking mechanism and the corkscrew with a ramped locking mechanism and one or two stainless steel bowls with a welded T-post are preferably sold together to allow a user to install the bowl for use on a floor, in the ground, or both interchangeably. Once the bolt and corkscrew are screwed into the floor and ground to the desired depth, they may be left in place and the pet bowl screwed on top for use by the pet and unscrewed for cleaning.

An advantage of the present invention is that the bowl may be simply removed for cleaning purposes and remote refilling.

A further advantage of the present invention is that the pet bowl is adjustable in height above a floor or the ground.

Another advantage of the present invention is that the mounting hardware may be sold with or without the bowl.

An additional advantage of the present invention is that may be used with standard pet bowls.

One more advantage of the present invention is that it is spill-proof.

Yet another advantage of the present invention is that it is simple and inexpensive to manufacture.

Still another advantage of the present invention is that it easily installed.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the bottom of a stainless steel pet bowl showing a threaded lag bolt with a welded ramped locking mechanism attached to the center of the pet bowl in the recessed bottom portion of the pet bowl;

FIG. 2 is a perspective view of the bottom of a stainless steel pet bowl showing a threaded corkscrew with a welded ramped locking mechanism attached to the center of the pet bowl in the recessed bottom portion of the pet bowl;

FIG. 3 is a side elevational view with a flat wooden support in cross-section showing the threaded lag bolt of FIG. 1 screwed into the wooden support and the pet bowl being lowered to mount the T-post on the bottom of the bowl onto the ramped locking mechanism on the top of the shaft of the lag bolt so that the pet bowl will be secured in an elevated position or in an alternate floor contacting position shown dashed;

FIG. 4 is a side elevational view with the ground in cross-section showing the corkscrew of FIG. 2 screwed into the ground and the pet bowl being lowered to mount the T-post on the bottom of the bowl onto the ramped locking mechanism on the top of the shaft of the corkscrew so that the pet bowl will be secured in an elevated position or in an alternate ground contacting position shown dashed;

FIG. 5 is a side elevational view of the bowl mounted on a shaft topped by the ramped locking mechanism which fits within the recessed bottom of the bowl;

FIG. 6 is a side elevational view of an L-shaped shaft with a ramped locking mechanism at the top of the vertical leg and a clamp at the end of the horizontal leg for mounting on a fence or vertical element, such as a fence post;

FIG. 7 is a top plan view of the L-shaped shaft of FIG. 6 with the clamp positioned to close around a fence post;

FIG. 8 is a side elevational view of a square Y-shaped mounting shaft with a ramped locking mechanism at the top of each of the arms of the Y and two bowls each with attached T-posts to provide both a water bowl and food bowl together, the Y-shaped mounting shaft having a bottom corkscrew screwed into the ground;

FIG. 9 is a side elevational view of a square Y-shaped mounting shaft with a ramped locking mechanism at the top of each of the arms of the Y and two bowls each with attached T-posts to provide both a water bowl and food bowl together, the Y-shaped mounting shaft having a bottom lag bolt screwed into a wooden surface;

FIG. 10 is a top plan view of the ramped locking mechanism;

FIG. 11 is an elevational view in partial section showing a bottom of the pet bowl with the T-shaped post of the present invention attached in the center of the bottom recess of the bowl;

FIG. 12 is a perspective view of the T-shaped post of the present invention;

FIG. 13 is an elevational view in partial section showing a bottom of the pet bowl with the T-shaped post of the present invention attached in the center of the bottom recess of the bowl and the bowl aligned for lowering the T-shaped post into the ramped locking mechanism attached to the top of either a lag bolt or a corkscrew;

FIG. 14 is a bottom plan view of the pet bowl with the attached T-shaped post of the present invention;

FIG. 15 is a perspective view of the ramped locking mechanism of the present invention with a top aligned for attachment, the top being slotted to receive the T-shaped post of the invention and the ramps and stops on the interior of the ramped locking mechanism visible.

### BEST MODE FOR CARRYING OUT THE INVENTION

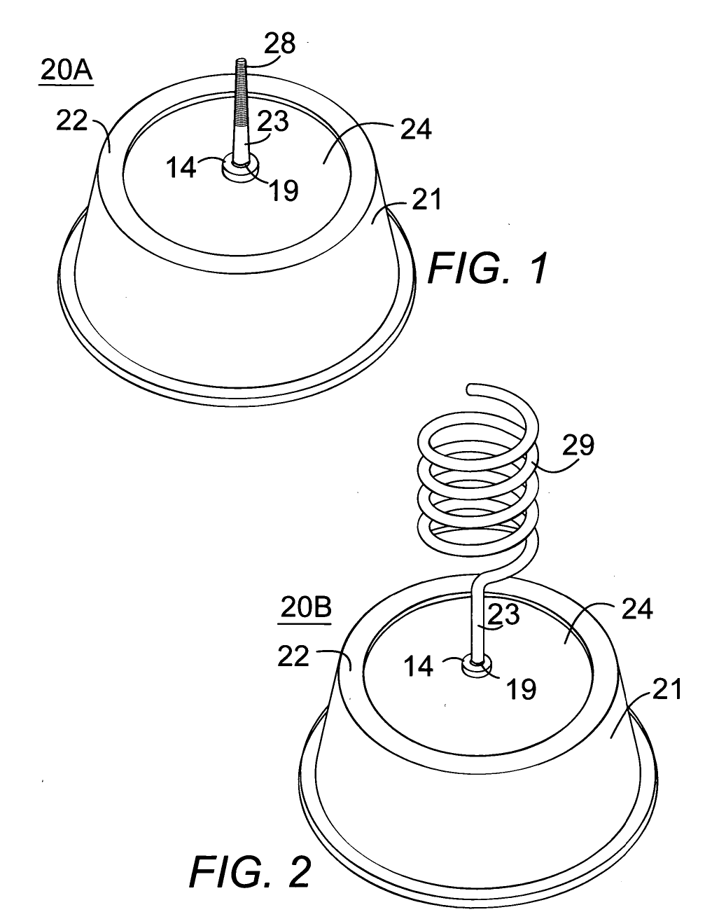

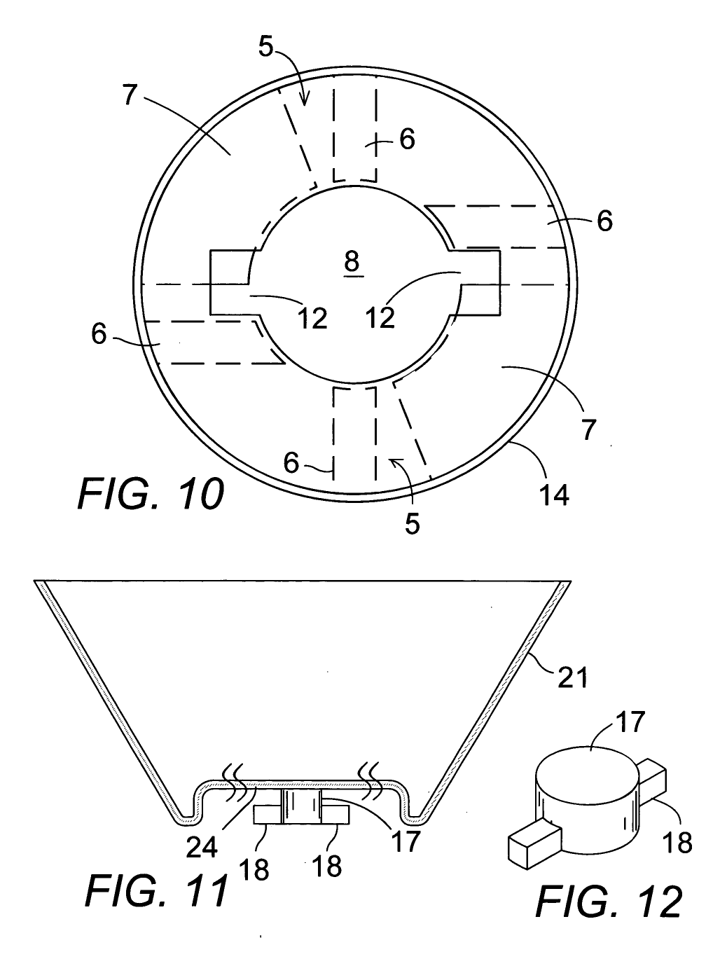

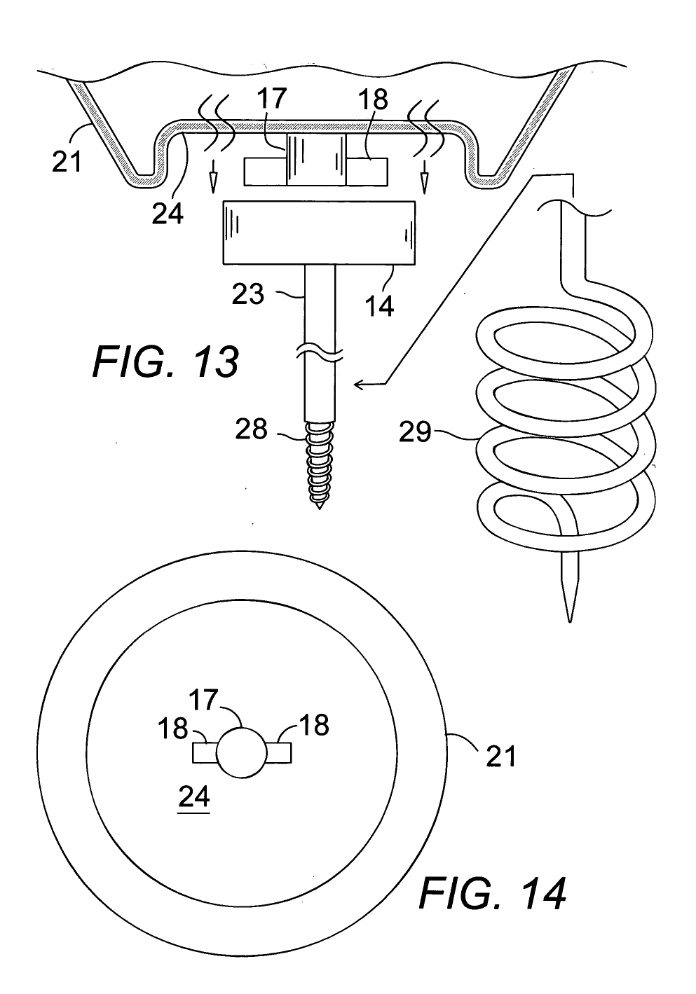

In FIGS. 1-15, a spill-proof adjustable height connector system 20A-20E for a food and water pet bowl that comprises a ramped locking mechanism 14 attached to a top of a shaft 23 having a threaded bottom end comprising either a bottom lag bolt thread 28 for spill-proof adjustable height installation on a wooden surface 30 or a corkscrew for spill-proof adjustable height installation in the ground 40 and a pet bowl 21 having an attached bottom T-shaped post 17 removably attachable to the ramped locking mechanism 14.

The rigid connector means for securing the bowl 21 to an external support surface comprises a locking post 17 attached to a bottom 24 of the recessed portion of the bowl, a rigid shaft 23 having a lower height adjustable attaching element 28, 29, 11A and 11B, for securing the rigid shaft 23 and 23A-23C. to an external support surface 30 and 40 at any of a range of adjustable heights, and a locking mechanism 14 attached to the top of the rigid shaft 23.

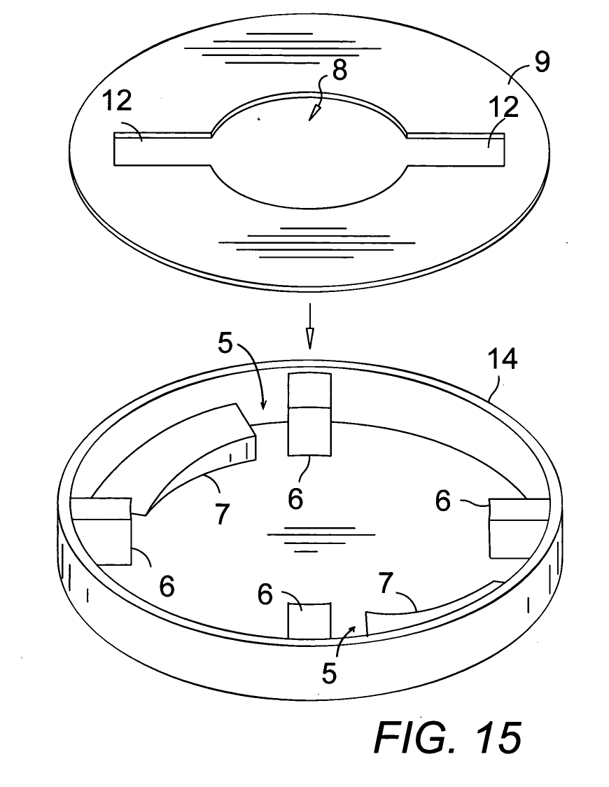

In FIGS. 10 and 15, the locking mechanism 14 has a top opening 8 and 12 and internal securing elements 6 and 7 for receiving and locking the locking post 17 from the pet bowl removably within the locking mechanism by lowering the pet bowl over the rigid shaft to insert the locking post in the locking mechanism so the bowl is rigidly supported at any of a range of adjustable heights without tipping and the locking post is releasable from the locking mechanism to remove the pet bowl for cleaning and remote refilling.

In FIGS. 11-14, the locking post comprises a T-shaped post having a cylindrical central rigid post 17 and two tabs 18 rigidly attached to the post and protruding from a distal end of the post, one tab on each side of the post. In FIGS. 10 and 15, the locking mechanism 14 comprises a ramped locking mechanism comprising a rigid chamber having a top opening with a circular center portion 8 to receive the cylindrical post and a pair of slots 12 extending out from each side of the circular center portion of the opening to receive the pair of tabs of the T-shaped post so that after the locking post is inserted in the locking mechanism and the post turned, the post cannot be pulled out of the locking mechanism. The ramped locking mechanism 14 houses a pair of internal spaced ramps 7 and stops 6 so that a T-shaped post 17 inserted in the ramped locking mechanism and turned is removably lockable by the tabs riding up the ramps 7 and falling into lower resting places 5 between the ramps 7 and the stops 6 preventing a turning motion of the tabs which must be lifted and turned back down the ramps to align with the opening 8 and 12 to release the T-shaped post 17 for removal of the pet bowl 21 from the shaft 23.

In FIGS. 1, 3, 9, and 13, the lower height adjustable attaching element for securing the rigid shaft to an external support surface at any of a range of adjustable heights comprises a lag bolt thread 28 on the end of the shaft 23 for self-threading to a desired depth into a wooden external support surface 40, such as a wooden floor surface, a wooden deck surface, a wooden patio surface, a wooden dock surface, and a wooden bench surface.

In FIGS. 2, 4, 8, and 13, the lower height adjustable attaching element for securing the rigid shaft to an external support surface at any of a range of adjustable heights comprises a rigid shaft portion formed in a corkscrew configuration 29 at a bottom end of the shaft 23, the corkscrew configuration adapted to be screwed into a ground external support surface 30 to a desired depth.

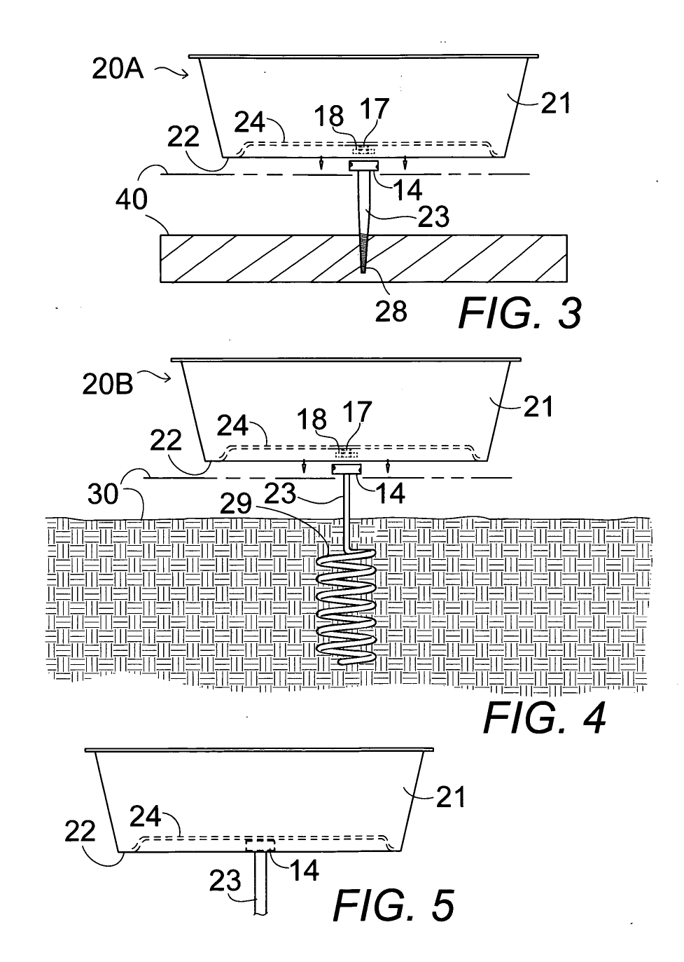

In FIGS. 1-5, and 11, the food and fluid consumption bowl 21 for pets to which the locking post 17 is attached preferably comprises a bowl 21 with a bottom comprising a raised recessed center portion 24 and a lower peripheral support portion 22 surrounding the recessed portion. The bottom support portion 22 has a flat surface for contacting an external support surface and the locking post 17 and locking mechanism 14 are sized to fit within the recessed center portion 24 of the bowl and the shaft may be adjusted in height to position the bowl to rest on a flat horizontal surface or be elevated above the flat horizontal surface at any of a variety of heights, as indicated by the solid and dashed floor levels 40 of FIG. 3 and the solid and dashed ground levels of FIG. 4.

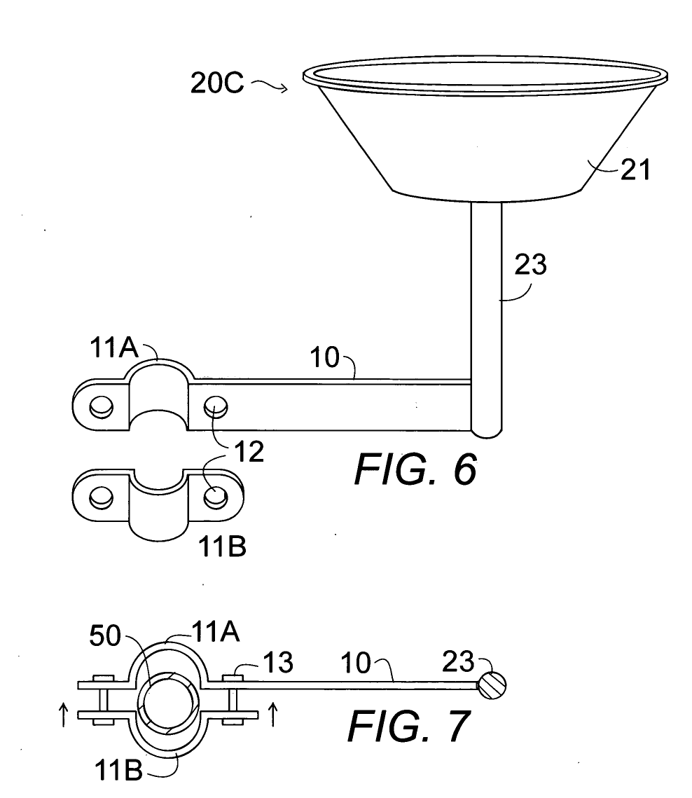

In FIGS. 6 and 7, the rigid shaft is an L-shaped shaft having a vertical leg 23 supporting the locking mechanism and a horizontal leg 10 extending from the bottom of the vertical leg and the lower height adjustable attaching element for securing the rigid shaft to an external support surface at any of a range of adjustable heights comprises a two-piece clamp 11A and 11B with mating bolt holes 12 and bolts 13 at the end of the horizontal leg for mounting on a vertical element 50, such as a post, at any desired height.

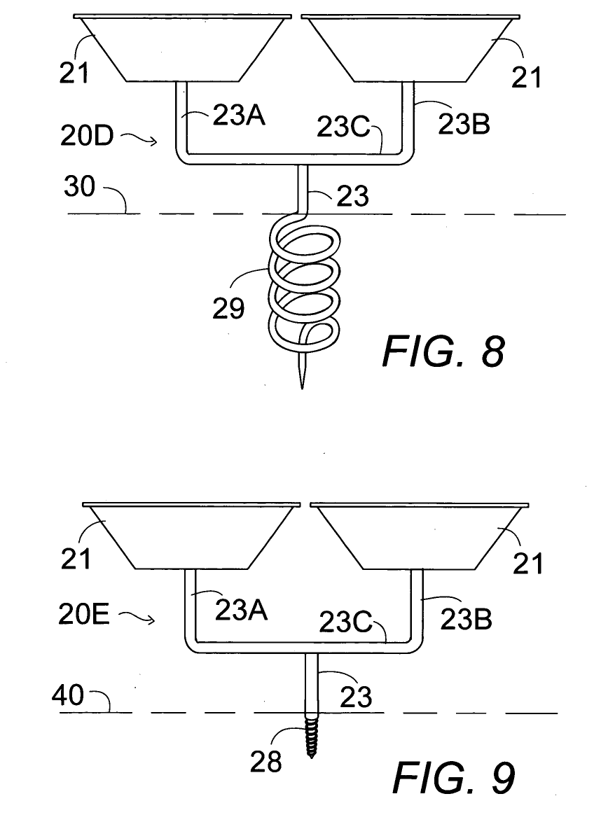

In FIGS. 8 and 9, the rigid shaft comprises a square Y-shaped mounting shaft having two vertical shafts 23A and 23B interconnected by a horizontal connector 23C which is attached in the center to the vertical shaft 23 with either a lag bolt end 28 of FIG. 9 or a corkscrew end 29 of FIG. 8. A locking mechanism (not shown) at the top of each of the vertical arms 23A and 23B of the Y receives a locking post (not shown) from a separate bowl so that two bowls 21 each attached to one of the shafts to provide both a water bowl and food bowl together.

For a stainless steel pet bowl the locking post is attached to the bottom of the bowl preferably by a metal weld or alternately by a screw means. For a plastic pet bowl the locking post is attached to the bottom of the bowl preferably by an adhesive or heat staking means or formed in the mold. For a clay-based pet bowl the locking post is attached to the bottom of the bowl by an adhesive. The means for attaching the locking mechanism 14 to the rigid shaft 23 comprises a metal weld.

It is understood that the preceding description is given merely by way of illustration and not in limitation of the invention and that various modifications may be made thereto without departing from the spirit of the invention as claimed.

What is claimed is:

1. A spill-proof connector system for a pet food and water bowl, the system comprising:
a rigid connector means for securing a pet bowl to an external support surface, the connector means comprising, a locking post attached to a bottom of the bowl, a rigid shaft having a lower height adjustable attaching element for securing the rigid shaft to an external support surface at any of a range of adjustable heights, a locking mechanism attached to the top of the rigid shaft, the locking mechanism having a top opening and internal securing elements for receiving and locking the locking post from the pet bowl removably within the locking mechanism by lowering the pet bowl over the rigid shaft to insert the locking post in the locking mechanism and turning the bowl so the bowl is rigidly supported at any of a range of adjustable heights without tipping and the locking post is releasable from the locking mechanism by turning the bowl to release the locking post from the locking mechanism to remove the pet bowl for cleaning and remote refilling.

2. The system of claim 1 wherein the locking post comprises a T-shaped post having a cylindrical central rigid post and two tabs rigidly attached to the post and protruding from a distal end of the post, one tab on each side of the post, and the locking mechanism comprises a ramped locking mechanism comprising a rigid chamber having a top opening with a circular center portion to receive the cylindrical post and a pair of slots extending out from each side of the circular center portion of the opening to receive the pair of tabs of the T-shaped post and the ramped locking mechanism housing a pair of internal spaced ramps and stops so that a T-shaped post inserted in the ramped locking mechanism and turned is removably lockable by the tabs riding up the ramps and falling into stops preventing turning motion of the tabs which must be lifted and turned back down the ramps to align with the opening to release the T-shaped post for removal of the pet bowl.

3. The system of claim 1 wherein the lower height adjustable attaching element for securing the rigid shaft to an external support surface at any of a range of adjustable heights comprises a lag bolt thread for self-threading into a wooden external support surface to a desired depth.

4. The system of claim 3 wherein the lag bolt thread is configured to be threaded into an external support surface taken from a list of external support surfaces including a wooden floor surface, a wooden deck surface, a wooden patio surface, a wooden dock surface, and a wooden bench surface.

5. The system of claim 1 wherein the lower height adjustable attaching element for securing the rigid shaft to an external support surface at any of a range of adjustable heights comprises a rigid shaft portion formed in a corkscrew configuration at a bottom end of the shaft, the corkscrew configuration adapted to be screwed into a ground external support surface to a desired depth.

6. The system of claim 1 wherein the rigid shaft is an L-shaped shaft having a vertical leg supporting the locking mechanism and a horizontal leg extending from the bottom of the vertical leg and the lower height adjustable attaching element for securing the rigid shaft to an external support surface at any of a range of adjustable heights comprises a clamp at the end of the horizontal leg for mounting on a vertical element at any desired height.

7. The system of claim 1 wherein the rigid shaft comprises a square Y-shaped mounting shaft with a locking mechanism at the top of each of the arms of the Y and two bowls each with attached bottom locking posts to provide both a water bowl and food bowl together.

8. The system of claim 1 wherein the food and fluid consumption pet bowl comprises a stainless steel pet bowl and the means of attaching the locking post to the bottom of the bowl comprises a metal weld.

9. The system of claim 1 wherein the food and fluid consumption pet bowl comprises a plastic pet bowl and the means of attaching the locking post to the bottom of the bowl comprises an adhesive.

10. The system of claim 1 wherein the food and fluid consumption pet bowl comprises a clay-based pet bowl and the means of attaching the locking post to the bottom of the bowl comprises an adhesive.

11. The system of claim 1 wherein the means for attaching the locking mechanism to the rigid shaft comprises a metal weld.

12. The system of claim 1 wherein a food and fluid consumption bowl for pets to which the locking post is attached comprises a bowl with a bottom comprising a raised recessed center portion and a lower peripheral support portion surrounding the recessed portion, the bottom support portion having a flat surface for contacting an external support surface and the locking post and locking mechanism are sized to fit within the recessed center portion of the bowl and the shaft may be adjusted in height to position the bowl to rest on a flat horizontal surface or be elevated above the flat horizontal surface at any of a variety of heights.
